(19) United States
(12) Patent Application Publication
(10) Pub. No.: US 2008/0282797 A1
(43) Pub. Date: Nov. 20, 2008

(54) Measuring bowl having handle

(76) Inventors: Donald Saller, Lucas, TX (US); James M. Smith, Dallas, TX (US)

Correspondence Address: EDWARD D. GILHOOLY, 28 E. JACKSON BLVD., SUITE 423, CHICAGO, IL, 60604, US

(21) Appl. No.: 12/075,309

(22) Filed: Mar. 10, 2008

Related U.S. Application Data
(60) Provisional application No. 60/906,026, filed on Mar. 9, 2007.

(51) Int. Cl. G01F 19/00

(52) U.S. Cl. 73/426

(57) ABSTRACT

A measuring bowl having an open top and concave body providing a material receiving chamber and having a flat bottom. A handle is attached to the concave body and includes a thumb hole to allow an individual to insert his or her thumb for comfortable and effective support and manipulation of the measuring bowl for receiving and pouring material. A pouring spout is provided on the concave body at a position from the handle. A pedestal is integral with the bottom wall for support of the bowl when not in use.

This application claims benefit of the filing date of provisional application Ser. No. 60/906,026 filed Mar. 9, 2007.

### BACKGROUND OF THE INVENTION

1. Field of the Invention

This invention relates to measuring bowls and more particularly, to measuring bowls having handles with a thumb hole.

2. Summary of the Prior Art

Measuring bowls are used to pour measured amounts of liquids or to particulate material for many uses in the household, restaurants, and for other well-know purposes. Many known designs do not offer a convenient and effective manner of manipulating the measuring cup. Therefore, it is desirable in the prior art to provide an effective and easy to use measuring vessel.

### SUMMARY OF THE INVENTION

It is an objective of this invention to provide a measuring bowl that is easy to manipulate. The invention herein uses a handle in which a hole is provided for the user's thumb, somewhat similar to an artist's palette. The invention provides an attractive and economical measuring cup that can steadily be held with one hand for receiving and measuring contents and pouring them in the measured amounts as needed for a particular use. The measuring bowl herein rests comfortably in an individual's hand and eliminates messy, slippery measuring bowls as in the prior art.

### BRIEF DESCRIPTION OF THE DRAWINGS

FIG. 1 is a front perspective view of a measuring bowl of the invention being held by a user;

FIG. 2 is a bottom perspective view of the measuring bowl of FIG. 1;

FIG. 3 is a front perspective view of a plurality of measuring bowls of FIG. 1 of various capacities being situated in a nested storage configuration; and

FIG. 4 is a front elevational view of the measuring bowl.

### DESCRIPTION OF THE PREFERRED EMBODIMENT

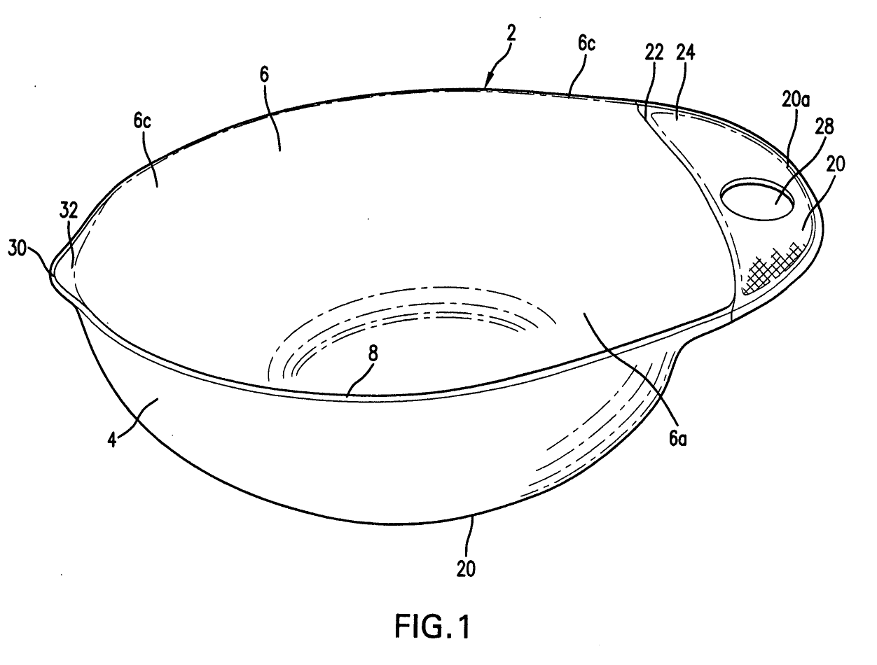

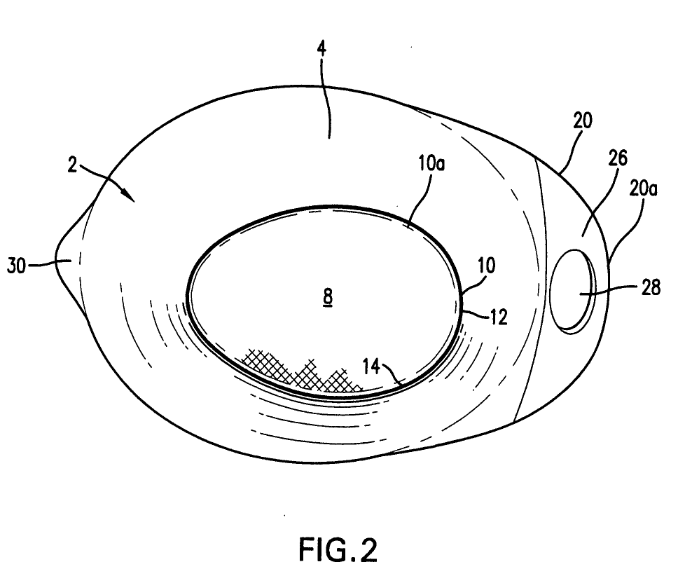

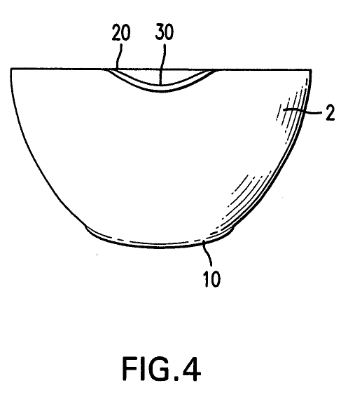

Referring now to FIGS. 1, 2 and 4, there is illustrated the measuring bowl of the invention for pouring and/or measuring quantities of liquid and particulate material, generally designated by reference numeral 2. The measuring bowl 2 includes a concave body 4 having an integral, continuous upright wall 6 formed with a modified oval horizontal cross-section and forms a chamber 6a having a open top 6b for receiving material to be poured and/or measured The body 4 is provided with flat bottom wall 8 integral with the upright wall 6 which flat bottom wall 8 has a modified oval cross-section in plan view, similar to the cross-sectional profile of an egg. The interior of the upright wall 6 can be display quantity indicia (not shown) for visually indicating desired quantity information. Although body 4 is shown with a particular shape, it is within the scope of the invention to form in other configurations of the body (not shown) to accomplish the objections of the invention. The upright wall 6 projects upward from bottom wall 8 and bows outward in an upward direction to said open top 6b. As seen in FIGS. 2 and 4, a lower pedestal 10 in the form of a circumferentially extending ridge with a cross-section in plan view generally outlining the cross-sectional shape of the bottom wall 8 extends downward from body 4 to provide a horizontal base surface 10a to elevate the bottom wall 8 from a support surface (not shown) when the bowl 2 is arranged upright to prevent marring of surfaces and a more staple foothold. As further seen in FIG. 2, the base surface 10a is formed with a continuous slot 12 for receiving a ring 14 projecting slightly beyond the base surface 10a. The ring 14 acts as a contact member as the bowl is supported upright on a surface.

A handle 20 is attached to a cut-out section 22 on the top portion 6c of upright wall 6. The handle 20 slopes outward from the bowl 2 with a curved upper surface 24 and a lower bottom surface 26. The outward edge portion 20a of the handle 20 is curved. A generally vertical hole 28 is formed through the handle 20 to receive the inserted thumb of an individual from below and be extended through the hole 28 as seen in FIG. 1. A portion of the inserted thumb contacts a portion of the upper surface 24. To stabilize the manipulation of the measuring bowl as needed in use, the fingers of the individual (not shown) support the bottom surface 26 of the handle 20 at the same time for manipulation with improved balance and manual control of the measuring cup, even the bowl is filled with a liquid or particulate material being measured and poured.

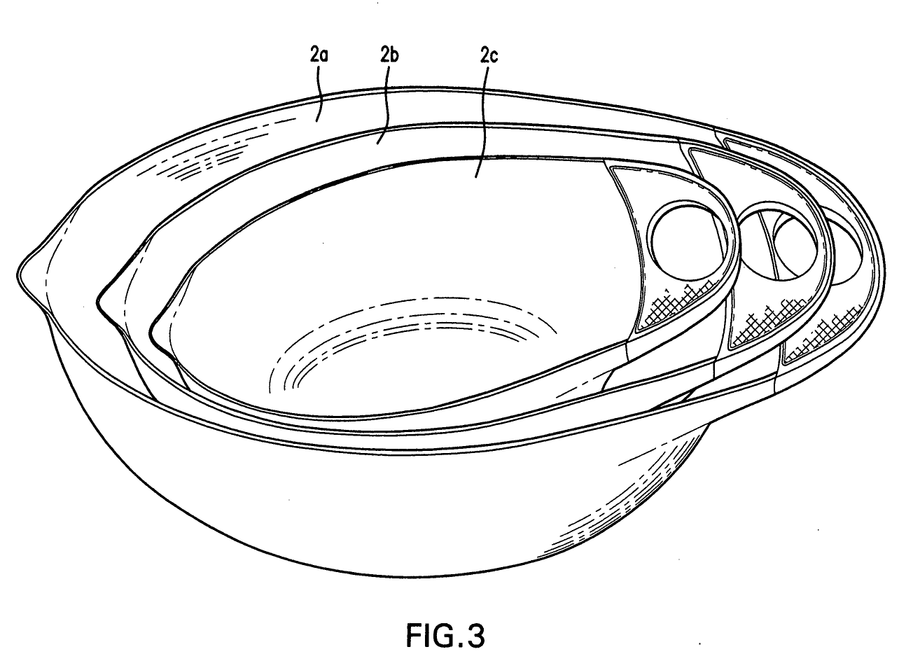

A spout 30 projects outward from the top portion 6c of the wall 8 at an opposite position from handle 20 and forms a concave upper surface 32 (FIG. 1) for control of pouring. As seen in FIG. 3, three measuring cups 2a, 2b, 2c of various capacities can be nested together for storage, since they are formed in corresponding matching exterior configurations. It should be apparent that two or more than three measuring cups 2 of progressive differing capacities can also be similarly arranged for storage.

What is claimed is:

1. A measuring bowl having a handle for receiving and pouring a flowable material comprising
a body having an open top and forming a chamber for receiving the flowable material,
said body having a circumferentially extending vertical wall and an integral bottom wall,
said body having a top portion disposed adjacent said opening and having a cut-out section,
a handle being affixed to said top portion at said cutout section and extending outward in a sloped relationship from said body, and
said handle having a vertically extending thumb hole, said handle arranged to receive the thumb of an individual for manipulation of the body with one hand.

2. The measuring bowl according to claim 1 wherein a spout area is formed on said top portion in projecting relationship to said body at a position generally opposite to said cut-out section.

3. The measuring bowl according to claim 2 wherein said spout forms an upper concave surface.

4. The measuring bowl according to claim 3 further including a base attached to said bottom wall for supporting said body upright.

5. The measuring bowl according to claim 1 wherein said base is a circumferentially extending ridge forming a base surface to contact a support surface.

6. The measuring bowl according to claim 1 wherein said base surface includes a slot for receiving a continuous ring.

7. The measuring bowl according to claim 6 wherein said vertical wall bows outward in upward direction from said bottom.
